(19) United States
(12) Patent Application Publication
(10) Pub. No.: US 2015/0246804 A1
(43) Pub. Date: Sep. 3, 2015

(54) BEVERAGE DISPENSING MACHINE

(71) Applicants: Matteo FRACASSI, Reggio Emilia (IT); Nicolò RONCHETTI, Località Sabbione, Reggio Emilia (IT); Maurizio GIACOPELLI, Località Rivalta, Reggio Emilia (IT)

(72) Inventors: Matteo FRACASSI, Reggio Emilia (IT); Nicolò RONCHETTI, Località Sabbione, Reggio Emilia (IT); Maurizio GIACOPELLI, Località Rivalta, Reggio Emilia (IT)

(21) Appl. No.: 14/635,629

(22) Filed: Mar. 2, 2015

(30) Foreign Application Priority Data
Mar. 3, 2014 (IT) MO2014A000052

(51) Int. Cl. B67D 1/06; B67D 1/00

(52) U.S. Cl. CPC B67D 1/06; B67D 1/0004; B67D 1/0015; B67D 2001/0091; B67D 2001/0094; B67D 2001/0814

(57) ABSTRACT

A beverage dispensing machine (1), comprising beverages discharge means (6, 71, 72) in turn comprising a first conduit (61) able to allow the exit of a beverage from at least one container (4).

The discharge means (6, 71, 72) include a discharge element (6) applicable to the mouth of the container and comprising both said first conduit (61) and at least a second conduit (62), separate from the first one and able to allow the entry of a top-up fluid from the outside into said container (4); and valve-flow control means (71, 72) for managing the passage of said beverage and said fluid respectively into the first and second conduit (61, 62).

The present invention relates to a beverage dispensing machine particularly intended for the preparation and distribution of cocktails.

It is known that in many public places such as bars, pubs, discos, etc . . . , beverages dispensing, with particular reference to alcoholic beverages, is one of the most important activities.

In said public places, one or more bartenders prepare cocktails by manually mixing the ingredients which often consist, at least partially, of liquor or other alcoholic beverages.

For thoroughly preparing beverages, individual skills are requested which are not always found in aforesaid public places bartenders.

In addition it takes quite a long time for a bartender to prepare and dispense the cocktails resulting in discomfort for customers which are forced to wait for a long time before their order is served.

For these reasons, devices have been conceived for automatically dispensing cocktails.

A device of the known type includes a plurality of tanks containing respective beverages taken consecutively via an electric pump and sent in sequence to a dispensing nozzle relative to which a glass to be filled is positioned.

Prior serving the order, the bartender mixes the beverage contained in the glass manually using special plastic sticks widely known in the industry.

This method of the known type is not fully satisfactory nor truly relevant to the needs of the field, although for the most part the bartender is not required to be particularly skilled.

In fact, first of all, it still takes a too long time for preparing cocktails, especially in peak periods when public places, massively attended by customers, are basically overloaded with orders.

Moreover, this method does not enable to take beverages out of the bottles in which they are sold, to the detriment of hygiene and practicality.

Further, the electric pump the beverage dispenser is provided with, is quite energy-consuming and expensive.

It is an object of the present invention to obviate the drawbacks as above mentioned by providing a beverage dispensing machine, in particular for cocktails, realized according to claim 1.

Further characteristics and advantages of the present invention will become more apparent from the indicative and therefore non-limiting description of a preferred but not exclusive embodiment of a beverage dispensing machine as illustrated in the appended drawings, wherein:

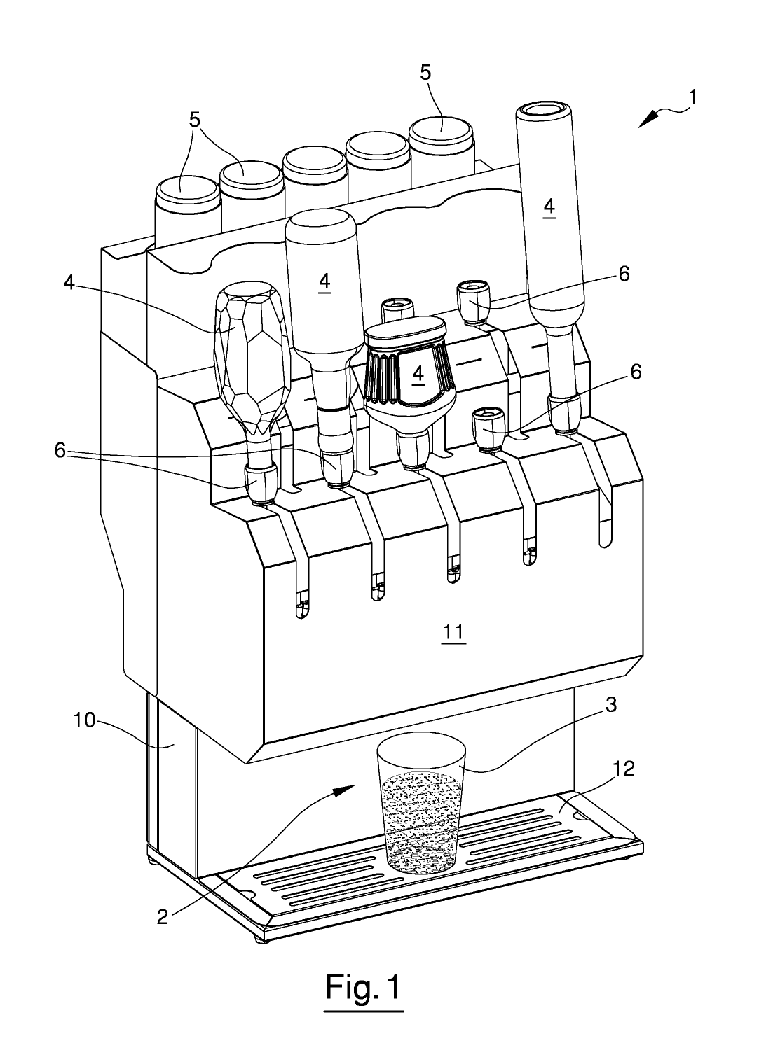

FIG. 1 is an isometric view of the machine of the invention;

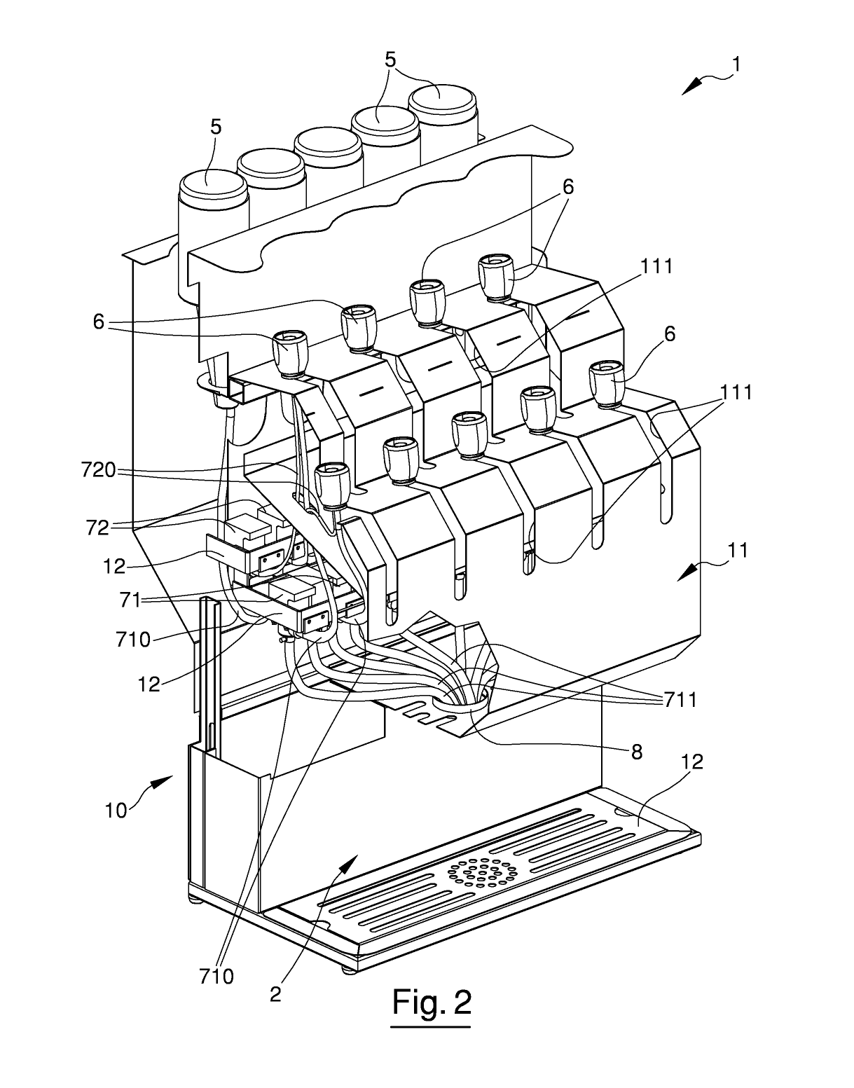

FIG. 2 is a cross-view of FIG. 1; and

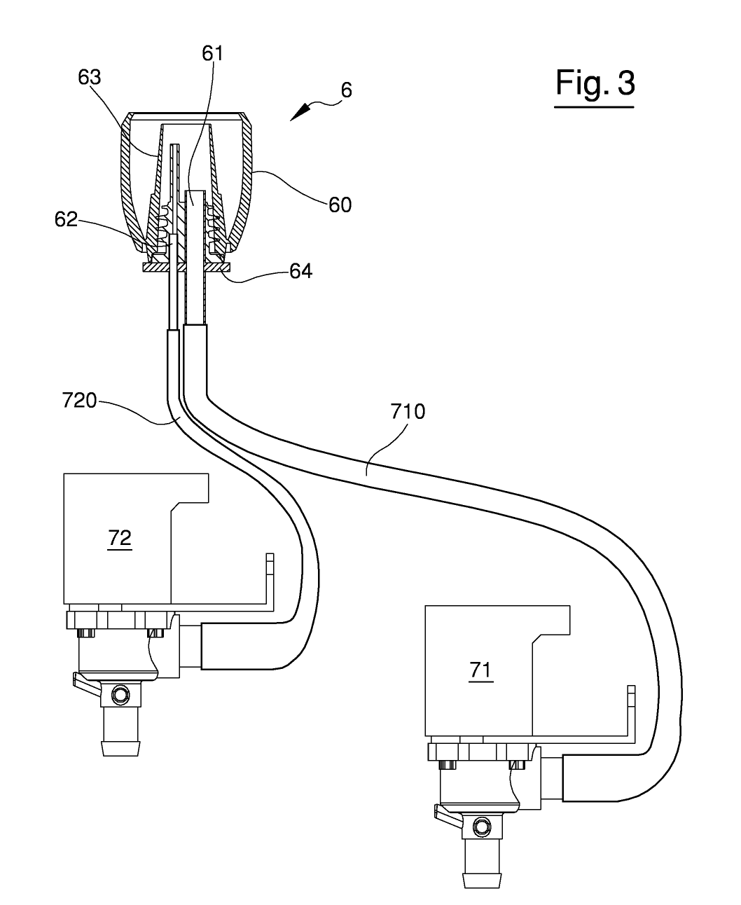

FIG. 3 is a schematic view of the discharge means of the invention.

With reference to the above figures, the machine object of the invention is referred to with numeral 1.

The proposed machine 1 has been devised for cocktails preparation and programmed dispensing thereof.

However, it can also be used for dispensing a single beverage at a time and not mixed with other beverages.

The machine 1 may include a support frame 10 arranged on a counter or other flat surface, on which support frame 10 the main components of the invention are mounted.

The machine 1 may also include an outer containment and protection casing 11 mounted on the support frame 10.

The proposed machine 1 includes discharge means 6, 71, 72 via which beverages are taken from respective containers 4, 5 and carried to a filling zone 2.

The filling zone 2 may be inferiorly defined by a supporting plane 12 for a glass 3, mounted on the frame 10 relative to the base thereof, which supporting plane 12 may be provided for example with through openings, overlooking the removable collecting and discharging tank.

The discharge means include a plurality of discharge elements 6, each applicable to the mouth of a container 4.

In the preferred embodiment of the invention shown in the appended figures, each discharge element 6 is tightly couplable to the opening of a bottle 4 obtained relative to the head thereof at the end of the so-called “neck”; in this manner the discharge element 6 plugs the bottle 4.

It should be appreciated that this allows use of commercial beverage bottles 4, a subject will be resumed in the detailed explanation which follows on the advantages of the invention.

In the present description, the discharge elements 6 of this preferred version of the machine 1 will be termed “plugs”.

In any case, the discharge elements 6 of the invention include both a first conduit 61 suitable for enabling exit of a beverage from the container towards said discharge zone, and a second conduit 62, separate from the first one, and able to allow entry of a top-up fluid from the outside into the container 4.

The second conduit 62 is mainly arranged for communicating with the environment outside the container 4, so as to allow entry of top-up air.

The first and second conduit 61, 62 are mutually non-intersecting, and preferably arranged parallel one to another.

An alternative and non-preferred embodiment according to which the invention provides one discharge element 6 only, is not to be excluded; however in such a case, the machine 1 would be less suitable for cocktails preparation albeit able to dispense drinks automatically.

In any event, as shown in FIG. 3, the above mentioned plugs 6 of the discharge means can be made of silicone, each comprising both an outer beaker-shaped body 60, which receives, preferably tightly, the head of the respective bottle 4, and an inner sleeve 63, coaxial to the beaker-shaped body 60, said sleeve 63 being destined to be snap-fit inserted into the head of the bottle 4 via its opening.

In this case, both the first and second conduits 61, 62 pass through the sleeve 63 parallel to the axis thereof so as to extend between the interior and the exterior of the bottle 4 the plug 6 is applied to.

The plug 6 obviously also includes a closing wall 64 crossed by the conduits 61, 62 and transverse with respect thereto, thereby preventing fluid communication other than through the conduits themselves.

Even more in detail, the beaker-shaped body 60 and the sleeve 63 can be made of a single unit and adapted to tightly receive, at one end of the sleeve 63, a closing insert conforming the wall 64 as well as the first and second conduit 62.

The first conduit 61 can have a greater light than the second conduit 62 (see FIG. 3).

In the preferred version of the invention, the plug 6 is adapted to support the respective bottle 4 at least partially in a vertical position, with the opening thereof facing downwards, thereby enabling the exit of the beverage by falling via the first conduit 61 of the plug 6.

In detail, the plug 6 can be movable between a position of use in which it receives the head of a bottle 4 arranged vertically and a position of intervention that allows the head of the bottle 4 to be applied to or removed from the plug 6 maintaining it horizontal.

This will be detailed in a later section.

All first conduits 61 of each discharge element 6 are included in a respective fluid-dynamic path ending in aforesaid filling zone 2, each path conveying the respective beverage to the same mixing manifold 8 which is arranged for dispensing a beverage or a mix of beverages in the glass 3 through falling.

According to an important aspect of the invention, the machine 1 includes valve flow-control means 71, 72 to manage the passage of beverages and top-up fluid respectively in the first and second conduits 61, 62 of each discharge element 6.

Said valve means 71, 72 are placed along fluid-dynamic paths as mentioned and are interposed between the first conduit 61 of the discharge elements 6 and the manifold 8 cited above, as detailed here below.

In the embodiment shown in FIGS. 2 and 3, for each discharge element 6, the valve means comprise a first solenoid valve 71 in fluid communication with the first conduit 61 for intercepting the beverage of the respective container, and a second solenoid valve 72 in fluid communication with the second conduit 62 for intercepting the top-up fluid, which is preferably air.

In this case, each valve 71, 72 may be of the normally closed two-way, two-position type; however, instead of two valves, the invention may also provide a single four-way and two-position valve for each discharge element 6 or eventually further solutions.

In practice, as will be detailed in the description on how the invention works, the machine 1 provides the controlled dispensing of each beverage upon opening of the respective solenoid valve 71.

As explained above, said beverage dispensing occurs through falling, that is to say owing to the mere gravity.

However, in order to prevent a vacuum from being created inside the bottle 4 following the exit of the beverage therefrom, thereby inhibiting subsequent dispensing, top-up air is sent into the bottle 4 through the second conduit 62 upon opening of the second solenoid valve 72.

In such a way, any pumps or other similar devices do not need to be provided for by the present invention.

According to a preferred constructive aspect, the first and second solenoid valve 71, 72 are tightly connected, respectively, to the first and second conduits 61, 62 of the respective plug 6 (or other type of discharge element), via tubes 710, 720 made up of food plastic or the like.

In detail, each first solenoid valve 71 is connected upstream to a tube 710 which connects it to the relative first conduit 61, and downstream to another tube 711 connecting it to the above cited manifold 8.

The second valve 720 located upstream is fluid-dynamically connected with the outer environment, that is with the ambient air, whereas downstream the same is connected via a tube 720 to the respective second conduit 62.

The machine 1 as proposed therefore includes a plurality of plugs 6 or other discharge elements 6 tightly connected with respective bottles 4, which beverages are addressed to the filling zone 2 in a selective way, according to the control mode of the valve means 71, 72.

Preferably, the invention comprises a control unit adapted to control the valve means 71, 72 selectively, so as to dispense beverages in different ways thereby obtaining a variety of cocktails.

In detail, the control unit is programmed to control the valve means 71, 72 so that they enable to simultaneously discharge a plurality of beverages, thereby obtaining a given cocktail.

Further, in the preferred version of the invention, wherein the valve means are the solenoid valves 71, 72 mentioned above, the control unit simultaneously activates the two solenoid valves associated with the selected beverage in order for it to be effectively dispensed.

The processing unit may comprise a microcontroller or microprocessor and is connectable in a known manner to computers, such as PC or tablet, etc.

According to a preferred constructive aspect shown in FIG. 2, the frame 10 provides an internal support structure generally indicated with the numeral 12 supporting more solenoid valves 71, 72, arranged for example such as to be aligned in two rows, of which the lower one includes the first solenoid valves 71, and the upper one comprises the second solenoid valves 72.

The aforementioned outer casing 11 can be configured for receiving and supporting the plugs 6 of the invention, for example arranged on two different rows at different heights.

In detail, for each plug 6 the casing 11 may include an extended through-slit 111 wherein the plug 6 is slidably inserted, the slit 111 extending from an upper end in which it lies on a horizontal plane, to one lower end in which it lies on a vertical plane.

Advantageously, the slits 111 act as guides so as to move relevant plug 6 between the abovementioned position of use, wherein axis thereof is substantially vertical, and the position of intervention, wherein said axis has been substantially rotated 180° so as to be essentially horizontal.

Prior to explaining the way the present invention works and the advantages thereof, an optional but preferred aspect thereto related, is described as illustrated both in FIGS. 1 and 2.

In order for beverages, particularly non-alcoholic beverages, to be dispensed which are not commercially provided for in bottles 4 couplable to the plugs 6 according to the present invention, the machine 1 comprises fluid-dynamically tanks connected to the outer environment, i.e. to the “free surface”.

Indeed, several cocktails imply adding of fruit juices, carbonated beverages, syrups, etc . . .

For this reason, the invention provides a plurality of tanks 5, each equipped with an opening on the bottom thereof that is tightly connected, through a special tube 712, to one of the first solenoid valve 71 or, in various embodiments, to other valve means.

In this specific embodiment, the tanks 5 need a single connection to a respective first solenoid valve 71, the top up occuring due the fact that said tanks 5 communicate directly with the outside.

However, especially in case of carbonated beverages, a variant of the invention is also possible wherein a “plug” system is associated to some of the tanks 5, in which the top up occurs by virtue of an entry of carbon dioxide or other gases performing same functions.

The way the present invention works is explained hereunder.

The user disposes the plugs 6 to be used with their axis horizontal in the position of intervention.

Then, he tightly inserts the heads of the bottles 4 into the plugs 6 in such a way as to not spill the beverage.

At this stage, the user puts the bottles 4 vertically with the opening thereof downwards by making relevant plugs 6 slide along the slits up to their upper end.

Additionally, the user fills the tanks 5 with the respective beverages.

Based on the ingredients prepared, a set of cocktails can be selected from among the ones programmed by the processing unit, as well as new ones may be improvised or a single beverage selected via a user interface provided for this purpose.

The interface may be incorporated in the casing 11 of the machine 1, for example of the “touch screen” type.

Once the type of cocktail to be prepared, for example the “Black Russian”, has been selected and the glass 3 arranged in the filling zone 2, the preparation and dispensing process starts.

The control unit simultaneously opens the two solenoid valves 71, 72 connected to the plug 6 of the vodka bottle and to the plug 6 of the coffee liqueur bottle for simultaneous dispensing.

Since the light of the conduits 61, 62 of the plugs 6 is known and fixed, the opening time of the solenoid valves 71, 72 automatically determines the amount of the ingredient beverage dispensed.

Therefore, the valves connected to the plug 6 of a given beverage will be kept open by the control unit for the time corresponding to the portion of that particular ingredient in the cocktail to be prepared.

While the beverages move along their fluid-dynamic path up to the single mixing fluid collector 8, the correct pressure within the concerned bottles 4 is restored by the air.

The beverages thus reach the collector 8 through the first solenoid valves 71 and above mentioned tubes 711 where they are mixed prior to being allowed to fall externally into the glass 3.

At this point, the cocktail is ready to be consumed.

It is to be noted that the distribution of cocktails by the proposed machine 1 is particularly rapid thanks to the fact that the solenoid valves 71, 72 associated to the different ingredients, open simultaneously and said ingredients are same time dispensed into the glass 3.

In this manner, the amount of orders that can be served in a unit of time increases significantly.

In addition, the single manifold 8 allows an automatic mixing of beverages for making cocktails which enables the user to avoid having to shake the beverage after dispensing thereof.

When the beverage in a bottle 4 is over, the user place it horizontally by making the plug 6 slide downwards along the slit 111, following to which the bottle is replaced.

Among further advantages of the invention there are those listed below.

The machine 1 is first and foremost designed in such a manner that it can be used with perfect effectiveness by any user, even if completely inexperienced as a bartender.

Furthermore, in order for cocktails to be dispensed, nothing is needed but a glass 3 in the filling zone 2, the user shall then intuitively act on the interface and finally serve the cocktail already prepared to the customer.

Owing to the fact that the structure of the machine 1 is userfriendly and compact, it can be used not only in pubs or the like, but also in homes, for example in basements, and can also be easily transported for outdoor parties, etc.

Thanks to the use of the machine according to the present invention, an always perfect and accurate cocktails preparation is obtained.

In fact, each cocktail of the same type dispensed by the machine 1, always consists of the same ingredients quantity which allows a more effective use of raw materials and above all a consistent quality.

Further, it is possible to automatically supervise and certify beverages dispensing, with particular reference to alcoholic beverages, in a given public place provided with the machine 1 of the invention.

Moreover, due to the fact that dispensing occurs solely according to the force of gravity, the proposed machine 1 is less expensive and complex than automated systems hitherto known.

1. A beverage dispensing machine (1), comprising beverages discharge means (6, 71, 72) in turn comprising at least a first conduit (61) able to allow the exit of a beverage from at least one container (4), said machine (1) being characterised in that said discharge means (6, 71, 72) include:
at least one discharge element (6) applicable to the mouth of the container and comprising both said first conduit (61) and at least a second conduit (62), separate from the first one, and able to allow the entry of a top-up fluid from the outside into said container (4); and
valve flow-control means (71, 72) for managing the passage of said beverage and said fluid respectively into the first and into the second conduit (61, 62).

2. The machine (1) according to claim 1, wherein said discharge element (6) is couplable to the opening of a bottle (4) so as to plug it.

3. The machine (1) according to claim 2, wherein said discharge element (6) comprises an outer beaker-shaped body (60) which receives the head of the respective bottle (4), and an inner sleeve (63) destined to be snap fit inserted into said opening, said first and second conduits (61, 62) being placed in the sleeve (63), so as to extend between the interior and the exterior of the bottle (4).

4. The machine (1) according to claim 3, wherein said discharge element (6) is able to support at least partially the respective bottle (4) in a vertical position, so as to allow exit of the beverage by falling via said first conduit (61).

5. The machine (1) according to claim 1, wherein said second conduit (62) is arranged to communicate with the outer environment so as to allow entry of top-up air into the relative container (4).

6. The machine (1) according to claim 1, wherein said valve means (71, 72) comprise at least a first solenoid valve (71) to intercept said beverage and a second solenoid valve (72) to intercept said top-up fluid.

7. The machine (1) according to claim 1, wherein said discharge means (6, 71, 72) include a plurality of pairs formed by relative first and second conduit (61, 62), each pair being connected to a respective container (4), the machine (1) further comprising a control unit adapted to control said valve means (71, 72) so as to dispense a plurality of beverages simultaneously.

8. The machine(1) according to claim 7, wherein all the first conduits (61) are in fluid communication with the same mixing manifold (8), provided for dispensing a beverage or a mixture of beverages in a glass.

9. The machine (1) according to claim 1, comprising at least one tank (5) for containing a beverage, provided with an opening which allows exit of the beverage according to the management of said valve means (71, 72).

10. The machine (1) according to claim 1, comprising a support frame (10) on which said discharge means (6, 71, 72) and said valve means (71, 72) are mounted.

11. The machine (1) according to claim 10 wherein each discharge element (6) is movable between a use position in which it receives the head of a bottle (4) arranged vertically and an intervention position allowing the head of the bottle (4) to be applied to or removed from said element (6), maintaining it horizontal.
